(19) United States
(12) Patent Application Publication
(10) Pub. No.: US 2017/0119018 A1
(43) Pub. Date: May 4, 2017

(54) COMPOSITIONS COMPRISING DEFATTED MICROALGAE, AND TREATMENT METHODS

(71) Applicant: CORNELL UNIVERSITY, Ithaca, NY (US)

(72) Inventor: Xingen LEI, Ithaca, NY (US)

(21) Appl. No.: 15/307,418

(22) PCT Filed: Apr. 28, 2015
(86) PCT No.: PCT/US15/28009

§ 371 Date: Oct. 28, 2016

Related U.S. Application Data
(60) Provisional application No. 61/985,106, filed on Apr. 28, 2014.

(51) Int. Cl. A23K 10/30; A23K 50/00; A23L 33/16; A23L 33/195; A23K 20/189; A23K 20/20

(52) U.S. Cl. CPC A23K 10/30; A23K 20/189; A23K 20/30; A23L 33/16; A23L 33/195; A23K 50/00; A23V 2002/00

(57) ABSTRACT

The present invention relates to a composition comprising defatted microalgae in a solid, powder, or liquid form formulated for oral administration. The present invention also relates to a composition comprising defatted microalgae formulated as a food additive. Also disclosed are treatment methods that involve administering microalgae compositions.

This application claims the benefit of U.S. Provisional Patent Application Ser. No. 61/985,106, filed Apr. 28, 2014, which is hereby incorporated by reference in its entirety.

### FIELD OF THE INVENTION

The present invention relates to compositions comprising defatted microalgae, and to treatment methods carried out by administering a composition comprising microalgae.

### BACKGROUND OF THE INVENTION

Iron is a mineral that is naturally present in many foods, added to some food products, and available as a nutritional (dietary) supplement (Iron, Dietary Supplemental Fact Sheet, National Institutes of Health, Office of Dietary Supplements, Feb. 19, 2015). Iron is an essential component of hemoglobin, an erythrocyte protein that transfers oxygen from the lungs to the tissues (M. Wessling-Resnick, Iron, in Modern Nutrition in Health and Disease 11^{th} ed., 176-88 (Ross, Caballero, Cousins, Tucker, Ziegler, eds., Lippincott Williams & Wilkins 2014)). As a component of myoglobin, a protein that provides oxygen to muscles, iron supports metabolism (P. J. Aggett, Iron in Present Knowledge in Nutrition 10^{th} ed., 506-20 (Erdman, Macdonald, Zeisel, eds., Wiley-Blackwell 2012)). Iron is also necessary for growth, development, normal cellular functioning, and synthesis of some hormones and connective tissue (P. J. Aggett, Iron in Present Knowledge in Nutrition 10^{th} ed., 506-20 (Erdman, Macdonald, Zeisel, eds., Wiley-Blackwell 2012); L. E. Murray-Kolbe & J. Beard, Iron in Encyclopedia of Dietary Supplements 2^{nd} ed., 432-8 (Coates, Betz, Blackman, eds. Informa Healthcare 2010)).

Dietary iron has two main forms: heme and nonheme (M. Wessling-Resnick, Iron, in Modern Nutrition in Health and Disease 11^{th} ed., 176-88 (Ross, Caballero, Cousins, Tucker, Ziegler, eds., Lippincott Williams & Wilkins 2014)). Plants and iron-fortified foods contain nonheme iron only, whereas meat, seafood, and poultry contain both heme and nonheme iron (P. J. Aggett, Iron in Present Knowledge in Nutrition 10^{th} ed., 506-20 (Erdman, Macdonald, Zeisel, eds., Wiley-Blackwell 2012)). Heme iron, which is formed when iron combines with protoporphyrin IX, contributes about 10% to 15% of total iron intakes in Western populations (L. E. Murray-Kolbe & J. Beard, Iron in Encyclopedia of Dietary Supplements 2^{nd} ed., 432-8 (Coates, Betz, Blackman, eds. Informa Healthcare 2010); Hurrell & Egli, “Iron Bioavailability and Dietary Reference Values,” Am. J. Clin. Nutr. 91:1461S-7S (2010); Institute of Medicine. Food and Nutrition Board. Dietary Reference Intakes for Vitamin A, Vitamin K, Arsenic, Boron, Chromium, Copper, Iodine, Iron, Manganese, Molybdenum, Nickel, Silicon, Vanadium, and Zinc: A Report of the Panel on Micronutrients, National Academy Press 2001).

Most of the 3 to 4 grams of elemental iron in adults is in hemoglobin (P. J. Aggett, Iron in Present Knowledge in Nutrition 10^{th} ed., 506-20 (Erdman, Macdonald, Zeisel, eds., Wiley-Blackwell 2012)). Much of the remaining iron is stored in the form of ferritin or hemosiderin (a degradation product of ferritin) in the liver, spleen, and bone marrow or is located in myoglobin in muscle tissue (M. Wessling-Resnick, Iron, in Modern Nutrition in Health and Disease 11^{th} ed., 176-88 (Ross, Caballero, Cousins, Tucker, Ziegler, eds., Lippincott Williams & Wilkins 2014); Institute of Medicine, Food and Nutrition Board, Dietary Reference Intakes for Vitamin A, Vitamin K, Arsenic, Boron, Chromium, Copper, Iodine, Iron, Manganese, Molybdenum, Nickel, Silicon, Vanadium, and Zinc: A Report of the Panel on Micronutrients, National Academy Press 2001). Humans typically lose only small amounts of iron in urine, feces, the gastrointestinal tract, and skin. Losses are greater in menstruating women because of blood loss. Hepcidin, a circulating peptide hormone, is the key regulator of both iron absorption and the distribution of iron throughout the body, including in plasma (M. Wessling-Resnick, Iron, in Modern Nutrition in Health and Disease 11^{th} ed., 176-88 (Ross, Caballero, Cousins, Tucker, Ziegler, eds., Lippincott Williams & Wilkins 2014); P. J. Aggett, Iron in Present Knowledge in Nutrition 10^{th} ed., 506-20 (Erdman, Macdonald, Zeisel, eds., Wiley-Blackwell 2012); Drakesmith, “Prentice AM. Hepcidin and the Iron-Infection Axis,” Science 338:768-72 (2012)).

Intake recommendations for iron and other nutrients are provided in the Dietary Reference Intakes (“DRIs”) developed by the Food and Nutrition Board (FNB) at the Institute of Medicine (IOM) of the National Academies (formerly National Academy of Sciences) (Institute of Medicine, Food and Nutrition Board, Dietary Reference Intakes for Vitamin A, Vitamin K, Arsenic, Boron, Chromium, Copper, Iodine, Iron, Manganese, Molybdenum, Nickel, Silicon, Vanadium, and Zinc: A Report of the Panel on Micronutrients, National Academy Press 2001). DRI is the general term for a set of reference values used for planning and assessing nutrient intakes of healthy people. These values, which vary by age and gender, include: (i) Recommended Dietary Allowance (“RDA”): average daily level of intake sufficient to meet the nutrient requirements of nearly all (97%-98%) healthy individuals; (ii) Adequate Intake (AI): established when evidence is insufficient to develop an RDA-intake at this level is assumed to ensure nutritional adequacy; (iii) Estimated Average Requirement (EAR): average daily level of intake estimated to meet the requirements of 50% of healthy individuals—this is usually used to assess the adequacy of nutrient intakes in population groups but not individuals; and (iv) Tolerable Upper Intake Level (UL): maximum daily intake unlikely to cause adverse health effects.

Iron is available in many dietary supplements. Multivitamin/multimineral supplements with iron, especially those designed for women, typically provide 18 mg iron (100% of the daily value (“DV”)). Multivitamin/multimineral supplements for men or seniors frequently contain less or no iron. Iron-only supplements usually deliver more than the DV, with many providing 65 mg iron (360% of the DV). Frequently used forms of iron in supplements include ferrous and ferric iron salts, such as ferrous sulfate, ferrous gluconate, ferric citrate, and ferric sulfate (L. E. Murray-Kolbe & J. Beard, Iron in Encyclopedia of Dietary Supplements 2^{nd} ed., 432-8 (Coates, Betz, Blackman, eds. Informa Healthcare 2010); Manoguerra et al., “Iron Ingestion: An Evidence-Based Consensus Guideline for Out-of-Hospital Management,” Clin. Toxicol. (Phila) 43:553-70 (2005)). Because of its higher solubility, ferrous iron in dietary supplements is more bioavailable than ferric iron (L. E. Murray-Kolbe & J. Beard, Iron in Encyclopedia of Dietary Supplements 2^{nd} ed., 432-8 (Coates, Betz, Blackman, eds. Informa Healthcare 2010)). High doses of supplemental iron (45 mg/day or more) may cause gastrointestinal side effects, such as nausea and constipation (Institute of Medicine, Food and Nutrition Board, Dietary Reference Intakes for Vitamin A, Vitamin K, Arsenic, Boron, Chromium, Copper, Iodine, Iron, Manganese, Molybdenum, Nickel, Silicon, Vanadium, and Zinc: A Report of the Panel on Micronutrients, National Academy Press 2001). Other forms of supplemental iron, such as heme iron polypeptides, carbonyl iron, iron amino-acid chelates, and polysaccharide-iron complexes, might have fewer gastrointestinal side effects than ferrous or ferric salts (Manoguerra et al., “Iron Ingestion: An Evidence-Based Consensus Guideline for Out-of-Hospital Management,” Clin. Toxicol. (Phila) 43:553-70 (2005)).

The different forms of iron in supplements contain varying amounts of elemental iron. For example, ferrous fumarate is 33% elemental iron by weight, whereas ferrous sulfate is 20% and ferrous gluconate is 12% elemental iron (Manoguerra et al., “Iron Ingestion: An Evidence-Based Consensus Guideline for Out-of-Hospital Management,” Clin. Toxicol. (Phila) 43:553-70 (2005)).

Approximately 14% to 18% of Americans use a supplement containing iron (U.S. Department of Agriculture, Agricultural Research Service, What We Eat in America, 2009-2010, 2012; Bailey et al., “Dietary Supplement Use in the United States, 2003-2006,” J. Nutr. 141:261-6 (2011)). Rates of use of supplements containing iron vary by age and gender, ranging from 6% of children aged 12 to 19 years to 60% of women who are lactating, and 72% of pregnant women (U.S. Department of Agriculture, Agricultural Research Service, What We Eat in America, 2009-2010, 2012; Cogswell et al., “Iron Supplement Use Among Women in the United States: Science, Policy and Practice,” J. Nutr. 133:1974S-7S (2003)).

Although fossil fuels are the major source of energy for heating, transportation, manufacturing, and the generation of electricity, these fuels are nonrenewable. Therefore, the search for renewable energy sources has become a key challenge of this century. Many species of microalgae contain large amounts of lipids that are suitable for the production of bio fuels, especially biodiesel (Gouveia et al, “Microalgae as Raw Material for Biofuels Production,” J. Ind. Microbiol. Biotechnol. 36:269-274 (2009)). Microalgae are the natural food source for many important aquaculture species such as molluscs, shrimps, and fish (Spolaore et al, “Commercial Applications of Microalgae,” J. Biosci. Bioeng. 101(2):87-96 (2006)), and several species of microalgae have been reported to be acceptable for inclusion in diets for swine, rabbits, broiler chickens, laying hens, and ruminant animals (Becker W. In: “Handbook of Microalgal Culture: Biotechnology and Applied Phycology,” Richmond, A. (Ed). Microalgae in Human and Animal Nutrition, Oxford, Blackwell Science, pp. 312-351 (2004); Becker, E. W., “Micro-Algae as a Source of Protein,” Biotech. Adv. 25:207-210 (2007)).

Microalgae are a rich source of protein, essential fatty acids, vitamins, and minerals (Becker W. In: “Handbook of Microalgal Culture: Biotechnology and Applied Phycology,” Richmond, A. (Ed), Microalgae in Human and Animal Nutrition, Oxford, Blackwell Science, pp. 312-351 (2004)). After lipid removal, the residual biomass contains even higher concentrations of protein and other nutrients. Microalgae are good sources of long chain polyunsaturated fatty acids (“PUFA”) and have been used to enrich diets with omega-3 PUFA (Herber et al., “Dietary Marine Algae Promotes Efficient Deposition of n-3 Fatty Acids for the Production of Enriched Shell Eggs,” Poult. Sci. 75:1501-1507 (1996); Barclay et al. In: The return of ω3 Fatty Acids into the Food Supply. I. Land-based Animal Food Products and their Health Effects, Simopoulos, A. P. (Ed). “Production of Docosahexaenoic Acid from Microalgae and Its Benefits for Use in Animal Feeds,” World Rev. Nutr. Diet. Basil, Karger 83:61-76 (1998); Nitsan et al, “Enrichment of Poultry Products with ω3 Fatty Acids by Dietary Supplementation with the Alga Nannochloropsis and Mantur Oil,” J. Agric. Food Chem. 47:5127-5132 (1999)). The defatted algae by-product of bio fuel production contains low contents of residual lipids containing long chain PUFA that may have significant nutritional value.

Chemically, defatted microalgae are uniquely different from other microalgae. They are supposed to contain high levels of ash and silicon (Si) in their cell membranes, and have unique morphological structures known as frustules (Martin-Jezequel et al., “Silicon Metabolism in Diatoms: Implications for Growth,” J. Phycol. 36:821-840 (2000)). Like most algae, they exhibit considerably higher sodium contents than land-based plants (Ruperez, P., “Mineral Content of Edible Marine Seaweeds,” Food Chem. 79:23-26 (2002)). Because high levels of ash (Keegan et al, “The Effects of Poultry Meal Source and Ash Level on Nursery Pig Performance,” J. Anim. Sci. 82:2750-2756 (2004)) and sodium (Gal-Garber et al., “Nutrient Transport in the Small Intestine: Na⁺, K⁺-ATPase Expression and Activity in the Small Intestine of the Chicken as Influenced by Dietary Sodium,” Poul. Sci. 82:1127-113 (2003)) and the balance of monovalent minerals (Leach et al., “Further Studies on Tibial Dyschondroplasia (Cartilage Abnormality) in Young Chicks,” J. Nutr. 102:1673-1680 (1972); Sauveur et al., “Interrelationship between Dietary Concentrations of Sodium, Potassium and Chloride in Laying Hens,” Br. Poult. Sci. 19:475-485 (1978)) affect body metabolism and health status, it remains to be determined if the defatted algae inclusion into animal diets causes toxicity or side effects such as feed refusal.

The present invention is directed to overcoming deficiencies in the art pertaining to compositions suitable for use as iron nutritional supplements and treatments of iron deficiency.

### SUMMARY OF THE INVENTION

One aspect of the present invention relates to a composition comprising defatted microalgae in a solid, powder, or liquid form formulated for oral administration.

Another aspect of the present invention relates to a composition comprising defatted microalgae formulated as a food additive.

A further aspect of the present invention relates to a method of treating iron deficiency in an iron deficient animal. This method involves identifying an iron deficient animal and administering to the iron deficient animal a composition comprising microalgae in a solid, powder, or liquid form formulated for oral administration under conditions effective to treat the iron deficient animal.

A further aspect of the present invention relates to a method of treating iron deficiency in an iron deficient animal. This method involves identifying an iron deficient animal and administering to the iron deficient animal a composition comprising microalgae formulated as a food additive under conditions effective to treat the iron deficient animal.

Yet another aspect of the present invention relates to a method of preventing iron deficiency in an animal. This method involves administering to an animal a composition comprising microalgae in a solid, powder, or liquid form formulated for oral administration under conditions effective to prevent iron deficiency in the animal.

Yet a further aspect of the present invention relates to a method of preventing iron deficiency in an animal. This method involves administering to an animal a composition comprising microalgae formulated as a food additive under conditions effective to prevent iron deficiency in the animal.

Still another aspect of the present invention relates to a method of hemoglobin repletion in a hemoglobin deficient animal. This method involves identifying a hemoglobin deficient animal and administering to the hemoglobin deficient animal a composition comprising microalgae in a solid, powder, or liquid form formulated for oral administration under conditions effective to replete hemoglobin in the animal.

Still a further aspect of the present invention relates to a method of hemoglobin repletion in a hemoglobin deficient animal. This method involves identifying a hemoglobin deficient animal and administering to the hemoglobin deficient animal a composition comprising microalgae formulated as a food additive under conditions effective to replete hemoglobin in the animal.

### DETAILED DESCRIPTION OF THE INVENTION

In one aspect, the present invention relates to a composition comprising defatted microalgae in a solid, powder, or liquid form formulated for oral administration.

In another aspect, the present invention relates to a composition comprising defatted microalgae formulated as a food additive.

As used herein, the term “microalgae” is used to mean eukaryotic microbial organisms that contain a chloroplast, and which may or may not be capable of performing photosynthesis. Microalgae include obligate photoautotrophs, which cannot metabolize a fixed carbon source as energy, as well as heterotrophs, which can live solely off of a fixed carbon source, including obligate heterotrophs, which cannot perform photosynthesis. In one embodiment, the microalgae are green marine microalgae. For example, and according to one embodiment, the microalgae are from the species Nannochloropsis oceanica.

Microalgae include, without limitation, unicellular organisms that separate from sister cells shortly after cell division, such as Chlamydomonas, as well as microbes such as, for example, Volvox, which is a simple multicellular photosynthetic microbe of two distinct cell types. Other microalgae may include cells such as Desmodesmus sp., Chlorella, Parachlorella, and Dunaliella. Chlorella is a genus of single-celled green algae, belonging to the phylum Chlorophyta. Chlorella cells are generally spherical in shape, about 2 to 10 μm in diameter, and lack flagella. Some species of Chlorella are naturally heterotrophic. Non-limiting examples of Chlorella species suitable in the compositions of the present invention include Chlorella protothecoides, Chlorella ellipsoidea, Chlorella minutissima, Chlorella zofinienesi, Chlorella luteoviridis, Chlorella kessleri, Chlorella sorokiniana, Chlorella fusca var. vacuolata Chlorella sp., Chlorella cf. minutissima, and Chlorella emersonii. Chlorella protothecoides, is known to have a high composition of lipids.

Other species of Chlorella suitable for use in the compositions of the present invention include, without limitation, the species anitrata, Antarctica, aureoviridis, candida, capsulate, desiccate, ellipsoidea (including strain CCAP 211/42), glucotropha, infusionum (including var. actophila and var. auxenophila), kessleri (including any of UTEX strains 397, 2229, 398), lobophora (including strain SAG 37.88), luteoviridis (including strain SAG 2203 and var. aureoviridis and lutescens), miniata, mutabilis, nocturna, ovalis, parva, photophila, pringsheimii, protothecoides (including any of UTEX strains 1806, 411, 264, 256, 255, 250, 249, 31, 29, 25 or CCAP 211/8D, or CCAP 211/17 and var. acidicola), regularis (including var. minima, and umbricata), reisiglii (including strain CCP 11/8), saccharophila (including strain CCAP 211/31, CCAP 211/32 and var. ellipsoidea), salina, simplex, sorokiniana (including strain SAG 211.40B), sphaerica, stigmatophora, trebouxioides, vanniellii, vulgaris (including strains CCAP 211/11K, CCAP 211/80 and f. tertia and var. autotrophica, viridis, vulgaris, tertia, viridis), xanthella, and zofingiensis.

Other genera and species of microalgae can also be used in the compositions of the present invention and may include, for example and without limitation, Achnanthes orientalis; Agmenellum; Amphiprora hyaline; Amphora, including A. coffeiformis including A.c. linea, A.c. punctata, A.c. taylori, A.c. tenuis, A.c. delicatissima, A.c. delicatissima capitata; Anabaena; Ankistrodesmus, including A. falcatus; Boekelovia hooglandii; Borodinella; Botryococcus braunii, including B. sudeticus; Bracteoccocus, including B. aerius, B. grandis, B. cinnabarinas, B. minor, and B. medionucleatus; Carteria; Chaetoceros, including C. gracilis, C. muelleri, and C. muelleri subsalsum; Chlorococcum, including C. infusionum; Chlorogonium; Chroomonas; Chrysosphaera; Cricosphaera; Crypthecodinium cohnii; Cryptomonas; Cyclotella, including C. cryptica and C. meneghiniana; Desmodesmus; Dunaliella, including D. bardawil, D. bioculata, D. granulate, D. maritime, D. minuta, D. parva, D. peircei, D. primolecta, D. salina, D. terricola, D. tertiolecta, and D. viridis; Eremosphaera, including E. viridis; Ellipsoidon; Euglena; Franceia; Fragilaria, including F. crotonensis; Gleocapsa; Gloeothamnion; Hymenomonas; Isochrysis, including I. affgalbana and I. galbana; Lepocinclis; Micractinium (including UTEX LB 2614); Monoraphidium, including M. minutum; Monoraphidium; Nannochloris; Nannochloropsis, including N. salina; N. avicula, including N. acceptata, N. biskanterae, N. pseudotenelloides, N. pelliculosa, and N. saprophila; Neochloris oleabundans; Nephrochloris; Nephroselmis; Nitschia communis; Nitzschia, including N. alexandrina, N. communis, N. dissipata, N. frustulum, N. hantzschiana, N. inconspicua, N. intermedia, N. microcephala, N. pusilla, N. pusilla elliptica, N. pusilla monoensis, and N. quadrangular; Ochromonas; Oocystis, including O. parva and O. pusilla; Oscillatoria, including O. limnetica and O. subbrevis; Parachlorella, including P. beijerinckii (including strain SAG 2046) and P. kessleri (including any of SAG strains 11.80, 14.82, 21.11H9); Pascheria, including P. acidophila; Pavlova; Phagus; Phormidium; Platymonas; Pleurochrysis, including P. carterae and P. dentate; Prototheca, including P. stagnora (including UTEX 327), P. portoricensis, and P. moriformis (including UTEX strains 1441, 1435, 1436, 1437, 1439); Pseudochlorella aquatica; Pyramimonas; Pyrobotrys; Rhodococcus opacus; Sarcinoid chrysophyte; Scenedesmus, including S. armatus and S. rubescens; Schizochytrium; Spirogyra; Spirulina platensis; Stichococcus; Synechococcus; Tetraedron; Tetraselmis, including T. suecica; Thalassiosira weissflogii; and Viridiella fridericiana.

In one embodiment, the microalgae are a diatom, e.g., diatom microalgae Staurosira sp. or Nannofrustulum. Diatoms are the major phytoplankton characterized by silica in the outer membrane of their cell walls. Diatoms construct ornamented shells of amorphous silica that contain complex material in their frustule structure. Studies on diatoms show that in some species, total amino acids found in the cell wall are 1.2-fold greater than those found in the cell contents. Also, certain amino acids appear to be consistently enriched in the cell wall compared to the cell contents, such as serine, threonine, and glycine.

A suitable source of microalgae for the compositions (and treatment methods discussed infra) of the present invention is microalgal biomass. Microalgal biomass is material produced by growth and/or propagation of microalgal cells. Microalgal biomass may contain cells and/or intracellular contents as well as extracellular material. Extracellular material includes, but is not limited to, compounds secreted by a cell.

Typically, microalgae are cultured in liquid media to propagate biomass. For example, microalgal species may be grown in a medium containing a fixed carbon and/or fixed nitrogen source in the absence of light. Such growth is known as heterotrophic growth. For some species of microalgae, heterotrophic growth for extended periods of time such as 10 to 15 or more days under limited nitrogen conditions results in accumulation of high lipid content in the microalgal cells.

In the compositions of the present invention, the microalgae are defatted microalgae. One particularly suitable source of defatted microalgae for use in the compositions of the present invention is microalgae cultivated for biofuel production. This includes microalgae that have undergone oil extraction. Thus, according to one embodiment, defatted microalgae have undergone an oil extraction process and so they contain less oil relative to microalgae prior to oil extraction. Cells of defatted microalgae are predominantly lysed. Defatted microalgae include microalgal biomass that has been solvent (e.g., hexane) extracted.

Oils harvested from microalgae include any triacylglyceride (or triglyceride oil) produced by microalgae. Defatted microalgae contain less oil by dry weight or volume than the microalgae contained before extraction. In one embodiment, defatted microalgae comprise about 0.1%-50%, 0.5%-45%, 1%-40%, 5%-35%, 10%-30%, 15%-25%, or about 20% of the oil content of non-defatted microalgae (i.e., microalgae before extraction). In another embodiment, in the defatted microalgae, approximately 30%-90% of the oil is extracted out. However, even after lipid extraction, the biomass still has a high nutrient value in content of protein and other constituents which makes it suitable for use in the compositions and treatment methods of the present invention.

For example, in one embodiment, the defatted microalgae comprise an adequate amount of iron for the defatted microalgae compositions to constitute an iron nutritional supplement. In one embodiment, the defatted microalgae comprises iron at a concentration of at least about 100 ppm, 105, ppm, 110 ppm, 115 ppm, 120 ppm, 125 ppm, 130 ppm, 135 ppm, 140 ppm, 145 ppm, or at least about 150 ppm.

Heme iron has higher bioavailability than nonheme iron, and other dietary components have less effect on the bioavailability of heme than nonheme iron (L. E. Murray-Kolbe & J. Beard, Iron in Encyclopedia of Dietary Supplements 2^{nd} ed., 432-8 (Coates, Betz, Blackman, eds. Informa Healthcare 2010); Hurrell & Egli, “Iron Bioavailability and Dietary Reference Values,” Am. J. Clin. Nutr. 91:1461 S-7S (2010), which are hereby incorporated by reference in their entirety). The bioavailability of iron is approximately 14% to 18% from mixed diets that include substantial amounts of meat, seafood, and vitamin C (ascorbic acid, which enhances the bioavailability of nonheme iron) and 5% to 12% from vegetarian diets (P. J. Aggett, Iron in Present Knowledge in Nutrition 10^{th} ed., 506-20 (Erdman, Macdonald, Zeisel, eds., Wiley-Blackwell 2012); Hurrell & Egli, “Iron Bioavailability and Dietary Reference Values,” Am. J. Clin. Nutr. 91:1461 S-7S (2010), which are hereby incorporated by reference in their entirety). In addition to ascorbic acid, meat, poultry, and seafood can enhance nonheme iron absorption, whereas phytate (present in grains and beans) and certain polyphenols in some non-animal foods (such as cereals and legumes) have the opposite effect (Hurrell & Egli, “Iron Bioavailability and Dietary Reference Values,” Am. J. Clin. Nutr. 91:1461 S-7S (2010), which is hereby incorporated by reference in its entirety). Unlike other inhibitors of iron absorption, calcium might reduce the bioavailability of both nonheme and heme iron. However, the effects of enhancers and inhibitors of iron absorption are attenuated by a typical mixed Western diet, so they have little effect on most people's iron status. Microalgae have high iron concentration and high bioavailability of that iron due to the form of iron (heme iron) contained in microalgae, and due to the presence of iron bioavailability enhancers (e.g., ascorbic acid and other organic acids) and low concentrations of iron bioavailability inhibitors (e.g., phytate and certain polyphenols).

In one embodiment, at least about 10%, 11%, 12%, 13%, 14%, 15%, 16%, 17%, 18%, 19%, or 20% of the iron contained in the defatted microalgae is high availability iron. In another embodiment, the defatted microalgae contain about 10% to about 20% high availability iron. As used herein, “high availability iron” is, according to one embodiment, heme iron. One of the benefits of defatted microalgae is that it contains a high amount of high availability iron, and at the same time also has high concentrations of iron bioavailability enhancers and low concentrations of iron bioavailability inhibitors.

The process of preparing defatted (or delipidated) microalgae for use in the compositions of the present invention can be carried out, for example, by lysing microalgal cells. This can be achieved by heat-induced lysis, adding a base, adding an acid, using enzymes such as proteases and polysaccharide degradation enzymes such as amylases, using ultrasound, mechanical pressure-based lysis, and lysis using osmotic shock. Each of these methods for lysing a microorganism can be used as a single method or in combination simultaneously or sequentially. The extent of cell disruption can be observed by microscopic analysis. Using one or more of the methods above, typically more than 70% cell breakage is observed.

Lipids and oils generated by the microalgae can be recovered by extraction. In some cases, extraction can be performed using an organic solvent or an oil, or can be performed using a solventless-extraction procedure.

For organic solvent extraction of the microalgal oil, the preferred organic solvent is hexane. Typically, the organic solvent is added directly to the lysate without prior separation of the lysate components. In one embodiment, the lysate generated by one or more of the methods described above is contacted with an organic solvent for a period of time sufficient to allow the lipid components to form a solution with the organic solvent. In some cases, the solution can then be further refined to recover specifically desired lipid components. The mixture can then be filtered and the hexane removed by, for example, rotoevaporation. Hexane extraction methods are well known in the art (see, e.g., Frenz et al., “Hydrocarbon Recovery by Extraction with a Biocompatible Solvent from Free and Immobilized Cultures of Botryococcus-braunii,” Enzyme Microb. Technol. 11:717-724 (1989), which is hereby incorporated by reference in its entirety.

Miao and Wu, “Biodiesel Production from Heterotrophic Microalgal Oil,” Biosource Technology 97:841-846 (2006), which is hereby incorporated by reference in its entirety, describe a protocol of the recovery of microalgal lipid from a culture of Chlorella protothecoides in which the cells were harvested by centrifugation, washed with distilled water, and dried by freeze drying. The resulting cell powder was pulverized in a mortar and then extracted with n-hexane.

In some cases, microalgal oils can be extracted using liquefaction (see, e.g., Sawayama et al., “Possibility of Renewable Energy Production and CO₂ Mitigation by Thermochemical Liquefaction of Microalgae,” Biomass and Bioenergy 17:33-39 (1999), which is hereby incorporated by reference in its entirety); oil liquefaction (see, e.g., Minowa et al., “Oil Production from Algal Cells of Dunaliella tertiolecta by Direct Thermochemical Liquefaction,” Fuel 74(12): 1735-1738 (1995), which is hereby incorporated by reference in its entirety); or supercritical CO₂ extraction (see, e.g., Mendes et al., “Supercritical Carbon Dioxide Extraction of Compounds with Pharmaceutical Importance from Microalgae,” Inorganica Chimica Acta 356:328-334 (2003), which is hereby incorporated by reference in its entirety). Algal oil extracted via supercritical CO₂ extraction contains all of the sterols and carotenoids from the algal biomass and naturally do not contain phospholipids as a function of the extraction process. The residual from the processes essentially comprises defatted (or delipidated) algal biomass devoid of oil, but still retains the protein and carbohydrates of the pre-extraction algal biomass. Thus, the residual defatted algal biomass is a suitable source of protein concentrate/isolate and dietary fiber, as well as an iron dietary or nutritional supplement.

Oil extraction also includes the addition of oil directly to a lysate without prior separation of the lysate components. After addition of the oil, the lysate separates either of its own accord or as a result of centrifugation or the like into different layers. The layers can include in order of decreasing density: a pellet of heavy solids, an aqueous phase, an emulsion phase, and an oil phase. The emulsion phase is an emulsion of lipids and aqueous phase. Depending on the percentage of oil added with respect to the lysate (w/w or v/v), the force of centrifugation, if any, volume of aqueous media, and other factors, either or both of the emulsion and oil phases can be present. Incubation or treatment of the cell lysate or the emulsion phase with the oil is performed for a time sufficient to allow the lipid produced by the microorganism to become solubilized in the oil to form a heterogeneous mixture.

Lipids can also be extracted from a lysate via a solventless extraction procedure without substantial or any use of organic solvents or oils by cooling the lysate. Sonication can also be used, particularly if the temperature is between room temperature and 65° C. Such a lysate on centrifugation or settling can be separated into layers, one of which is an aqueous:lipid layer. Other layers can include a solid pellet, an aqueous layer, and a lipid layer. Lipid can be extracted from the emulsion layer by freeze thawing or otherwise cooling the emulsion. In such methods, it is not necessary to add any organic solvent or oil. If any solvent or oil is added, it can be below 5% v/v or w/w of the lysate.

According to one embodiment, the defatted microalgae in the compositions of the present invention is dried and/or ground into microalgal meal and then, optionally, produced into a powder. Drying microalgal biomass, either predominantly intact or in homogenate form, is advantageous to facilitate further processing or for use of the biomass in the compositions of the present invention. Drying refers to the removal of free or surface moisture/water from predominantly intact biomass or the removal of surface water from a slurry of homogenized (e.g., by micronization) biomass.

In one embodiment, concentrated microalgal biomass is drum dried to a flake form to produce microalgal flake. In another embodiment, the concentrated microalgal biomass is spray or flash dried (i.e., subjected to a pneumatic drying process) to form a powder containing predominantly intact cells to produce microalgal powder. In another embodiment, the concentrated microalgal biomass is micronized (homogenized) to form a homogenate of predominantly lysed cells that is then spray or flash dried to produce microalgal flour.

In one embodiment of the compositions of the present invention, the microalgae component is in the form of flour, flake, or powder and contains 15% or less, 10% or less, 5% or less, 2-6%, or 3-5% moisture by weight after drying.

In one embodiment, the microalgae of the compositions of the present invention include only defatted (or delipidated) microalgae. In another embodiment, the microalgae compositions include a combination of defatted microalgae and full-fat microalgae.

Microalgae, either defatted or full-fat, also contain high quality proteins, carbohydrates, fiber, ash, and other nutrients.

The compositions of the present invention containing defatted microalgae are formulated, e.g., for consumption as a dietary, nutritional, or food supplement. In one aspect, a composition comprising defatted microalgae is in a solid, powder, or liquid form and is formulated for oral administration. In another aspect, a composition comprising defatted microalgae is formulated as a food additive.

As used herein, “formulated” compositions of the present invention mean compositions comprising (defatted) microalgae with, for example, suitable excipients, stabilizers, binders, etc., that help make a stable microalgae containing composition that is suitable for oral consumption either as a dietary or nutritional supplement or as a food additive. For example, the compositions of the present invention can be formulated into solid, powder, or liquid forms.

To prepare the formulated compositions of the present invention, the defatted microalgae may be combined in admixture with a suitable excipient, stabilizer, binder, etc. For example, the composition may be formulated for oral administration in solid, powder, or liquid form. For liquid preparations (e.g., suspensions, emulsions, mixtures, elixirs, solutions, etc.), media containing, for example water, oils, alcohols, flavoring agents, preservatives, coloring agents and the like may be used. Alternatively, pharmaceutical or nutraceutical carriers such as starches, sugars, diluents, granulating agents, lubricants, binders, disintegrating agents and the like may be used to prepare solid formulations (e.g., powders, caplets, pills, tablets, capsules, lozenges, etc.).

Controlled release forms may also be used. Because of their ease in administration, caplets, tablets, pills, and capsules represent the most advantageous oral dosage unit form, in which case solid carriers are employed. If desired, tablets may be sugar coated or enteric coated by standard techniques. All of these pharmaceutical carriers and formulations are well known to those of ordinary skill in the art. See, e.g., Ainley Wad and Paul J. Weller, Handbook of Pharmaceutical Excipients, A. H. Kibbe, ed., 3^{rd} sub.ed. (Amer Pharmaceutical Assn, 2000), which is hereby incorporated by reference in its entirety).

In one embodiment of the composition of the present invention, the composition is formulated into an oral dosage form that is swallowable, chewable, or dissolvable. Swallowable compositions are well known in the art and are those that do not readily dissolve when placed in the mouth and may be swallowed whole without any chewing or discomfort. In a specific embodiment of the present invention, the swallowable composition may have a shape containing no sharp edges and a smooth, uniform, and substantially bubble free outer coating.

To prepare the swallowable compositions of the present invention, the defatted microalgae may be combined in intimate admixture with a suitable carrier (e.g., excipients, stabilizers, binders, etc.) according to conventional compounding techniques. In a specific embodiment of the swallowable composition of the present invention, the surface of the composition may be coated with a polymeric film. Such a film coating has several beneficial effects. First, it reduces the adhesion of the compositions to the inner surface of the mouth, thereby increasing one's ability to swallow the compositions. Second, the film may aid in masking the unpleasant taste of certain ingredients. Third, the film coating may protect the composition of the present invention from atmospheric degradation. Polymeric films that may be used in preparing the swallowable compositions of the present invention include vinyl polymers such as polyvinylpyrrolidone, polyvinyl alcohol, and acetate, cellulosics such as methyl and ethyl cellulose, hydroxyethyl cellulose and hydroxylpropyl methylcellulose, acrylates, and methacrylates, copolymers such as the vinyl-maleic acid and styrene-maleic acid types, and natural gums and resins such as zein, gelatin, shellac, and acacia.

Chewable compositions are those that have a palatable taste and mouthfeel, are relatively soft, and quickly break into smaller pieces and begin to dissolve after chewing such that they are swallowed substantially as a solution.

To create chewable compositions, certain ingredients should be included to achieve the attributes just described. For example, chewable compositions should include ingredients that create pleasant flavor and mouthfeel and promote relative softness and dissolvability in the mouth. The following discussion describes ingredients that may help to achieve these characteristics.

A variety of ingredients can be included in the compositions of the present invention to enhance mouthfeel. In the chewable compositions of the present invention, sugars such as white sugar, corn syrup, sorbitol (solution), maltitol (syrup), oligosaccharide, isomaltooligosaccharide, sucrose, fructose, lactose, glucose, lycasin, xylitol, lactitol, erythritol, mannitol, isomaltose, dextrose, polydextrose, dextrin, compressible cellulose, compressible honey, compressible molasses and mixtures thereof may be added to improve mouthfeel and palatability. Further, by way of example and without limitation, fondant or gums such as gelatin, agar, arabic gum, guar gum, and carrageenan may be added to improve the chewiness of the compositions. Fatty materials that may be included in the present invention include, by way of example and without limitation, vegetable oils (including palm oil, palm hydrogenated oil, corn germ hydrogenated oil, castor hydrogenated oil, cotton-seed oil, olive oil, peanut oil, palm olein oil, and palm stearin oil), animal oils (including refined oil and refined lard whose melting point ranges from 30° C. to 42° C.), Cacao fat, margarine, butter, and shortening.

Alkyl polysiloxanes (commercially available polymers sold in a variety of molecular weight ranges and with a variety of different substitution patterns) also may be used in the present invention to enhance the texture, the mouthfeel, or both of the chewable compositions described herein. By “enhance the texture” it is meant that the alkyl polysiloxane improves one or more of the stiffness, the brittleness, and the chewiness of the chewable composition, relative to the same preparation lacking the alkyl polysiloxane. By “enhance the mouthfeel” it is meant that the alkyl polysiloxane reduces the gritty texture of the composition once it has liquefied in the mouth, relative to the same preparation lacking the alkyl polysiloxane.

Alkyl polysiloxanes generally comprise a silicon and oxygen-containing polymeric backbone with one or more alkyl groups pending from the silicon atoms of the back bone. Depending upon their grade, they can further comprise silica gel. Alkyl polysiloxanes are generally viscous oils. Exemplary alkyl polysiloxanes that can be used in the swallowable, chewable or dissolvable compositions of the present invention include, by way of example and without limitation, monoalkyl or dialkyl polysiloxanes, where the alkyl group is independently selected at each occurrence from a C₁-C₆-alkyl group optionally substituted with a phenyl group. A specific alkyl polysiloxane that may be used is dimethyl polysiloxane (generally referred to as simethicone). More specifically, a granular simethicone preparation designated simethicone GS may be used. Simethicone GS is a preparation which contains 30% simethicone USP.

Chewable compositions should begin to break and dissolve in the mouth shortly after chewing begins such that the compositions can be swallowed substantially as a solution. The dissolution profile of chewable compositions may be enhanced by including rapidly water-soluble fillers and excipients. Rapidly water-soluble fillers and excipients preferably dissolve within about 60 seconds of being wetted with saliva. Indeed, it is contemplated that if enough water-soluble excipients are included in the compositions of the present invention, they may become dissolvable rather than chewable composition forms. Examples of rapidly water soluble fillers suitable for use with the present invention include, by way of example and without limitation, saccharides, amino acids, and the like. Disintegrants also may be included in the compositions of the present invention in order to facilitate dissolution. Disintegrants, including permeabilizing and wicking agents, are capable of drawing water or saliva up into the compositions which promotes dissolution from the inside as well as the outside of the compositions. Such disintegrants, permeabilizing and/or wicking agents that may be used in the present invention include, by way of example and without limitation, starches, such as corn starch, potato starch, pre-gelatinized, and modified starches thereof, cellulosic agents, such as Ac-di-sol, montrnorrilonite clays, cross-linked PVP, sweeteners, bentonite, microcrystalline cellulose, croscarmellose sodium, alginates, sodium starch glycolate, gums, such as agar, guar, locust bean, karaya, pectin, Arabic, xanthan and tragacanth, silica with a high affinity for aqueous solvents, such as colloidal silica, precipitated silica, maltodextrins, beta-cyclodextrins, polymers, such as carbopol, and cellulosic agents, such as hydroxymethylcellulose, hydroxypropylcellulose and hydroxyopropylmethylcellulose.

Dissolution of the compositions may be facilitated by including relatively small particles sizes of the ingredients (i.e., defatted microalgae) used.

In addition to those described above, any appropriate fillers and excipients may be utilized in preparing the swallowable, chewable, and/or dissolvable compositions of the present invention so long as they are consistent with the objectives described herein. For example, binders are substances used to cause adhesion of powder particles in granulations. Such compounds appropriate for use in the present invention include, by way of example and without limitation, acacia, compressible sugar, gelatin, sucrose and its derivatives, maltodextrin, cellulosic polymers, such as ethylcellulose, hydroxypropylcellulose, hydroxypropylmethyl cellulose, carboxymethylcellulose sodium and methylcellulose, acrylic polymers, such as insoluble acrylate ammoniomethacrylate copolymer, polyacrylate or polymethacrylic copolymer, povidones, copovidones, polyvinylalcohols, alginic acid, sodium alginate, starch, pregelatinized starch, guar gum, polyethylene glycol and others known to those of ordinary skill in the art.

Diluents also may be included in the compositions of the present invention in order to enhance the granulation of the compositions. Diluents can include, by way of example and without limitation, microcrystalline cellulose, sucrose, dicalcium phosphate, starches, lactose and polyols of less than 13 carbon atoms, such as mannitol, xylitol, sorbitol, maltitol, and pharmaceutically acceptable amino acids, such as glycin, and their mixtures.

Lubricants are substances used in composition formulations that reduce friction during composition compression. Lubricants that may be used in the present invention include, by way of example and without limitation, stearic acid, calcium stearate, magnesium stearate, zinc stearate, talc, mineral and vegetable oils, benzoic acid, poly(ethylene glycol), glyceryl behenate, stearyl fumarate, and others known to those of ordinary skill in the art.

Glidants improve the flow of powder blends during manufacturing and minimize composition weight variation. Glidants that may be used in the present invention include, by way of example and without limitation, silicon dioxide, colloidal or fumed silica, magnesium stearate, calcium stearate, stearic acid, cornstarch, talc and others known to those of ordinary skill in the art.

Colorants also may be included in the compositions of the present invention. As used herein, the term “colorant” includes compounds used to impart color to formulated compositions of the present invention. Such compounds include, by way of example and without limitation, FD&C Red No. 3, FD&C Red No. 20, FD&C Yellow No. 6, FD&C Blue No. 2, D&C Green No. 5, FD&C Orange No. 5, D&C Red No. 8, caramel, ferric oxide, red, and others known to those of ordinary skill in the art. Coloring agents also can include pigments, dyes, tints, titanium dioxide, natural coloring agents, such as grape skin extract, beet red powder, beta carotene, annato, carmine, turmeric, paprika and others known to those of ordinary skill in the art. It is recognized that no colorant is required in the formulated compositions described herein.

If desired, the formulated compositions of the present invention may be sugar coated or enteric coated by standard techniques. The unit dose forms may be individually wrapped, packaged as multiple units on paper strips or in vials of any size, without limitation. The formulated compositions of the present invention may be packaged in unit dose, rolls, bulk bottles, blister packs, and combinations thereof, without limitation.

In another embodiment, the defatted microalgae composition may be formulated into the form of a liquid gelcap. This may comprise the defatted microalgae suspended in, dissolved in, or contained in an appropriate liquid vehicle encapsulated in a gelatin shell generally comprising gelatin together with a plasticizer such as glycerin or sorbitol. The filler material may comprise, for example, polyethylene glycols. See, for example, U.S. Pat. Nos. 4,780,316; 5,419,916; 5,641,512; and 6,589,536, which are hereby incorporated by reference in their entirety.

A liquid gelcap may have numerous advantages. First, it retains many of the advantages of consumer acceptance and may be easier to swallow than a compressed tablet due to the outer coating being a soft and elastic gelatin shell. Also, liquid compositions are well suited for encapsulation within a soft gelatin shell, creating flexibility that further assists in the capsule being easier to swallow.

In a specific embodiment, the composition may be formulated in a dosage form of a soft-gel gelcap. A soft-gel is a one-piece, sealed, soft gelatin shell that contains a solution, a suspension, or a semi-solid paste. Soft-gels are predominantly used to contain liquids where the active ingredient(s) are present in the dissolved or suspended state. Soft-gels have been widely known and used for many years and for a variety of purposes. Because soft-gels have properties that are quite different from two-piece, hard shell capsules, the soft-gels are capable of retaining a liquid fill material. Soft-gels are often used to encapsulate consumable materials, including vitamins, dietary supplements, pharmaceuticals, and the like, in a liquid vehicle or carrier. Soft-gels are a unique dosage form that can provide distinct advantages over more traditional dosage forms such as tablets, hard-shell capsules, and liquids. These advantages include patient compliance and consumer preference, improved bioavailability, speed of product development, shortened manufacturing time, enhanced drug stability due to less exposure of the active ingredient to oxygen, excellent dose uniformity, and product differentiation.

The formulated compositions of the present invention may be prepared using conventional methods and materials known in the pharmaceutical art. For example, U.S. Pat. Nos. 5,215,754 and 4,374,082, which are hereby incorporated by reference in their entirety, relate to methods for preparing swallowable compositions. U.S. Pat. No. 6,495,177, which is hereby incorporated by reference in its entirety, relates to methods to prepare chewable nutritional supplements with improved mouthfeel. U.S. Pat. No. 5,965,162, which is hereby incorporated by reference in its entirety, relates to kits and methods for preparing multi-vitamin comestible units which disintegrate quickly in the mouth, especially when chewed.

A specific embodiment of the present invention comprises formulated compositions packaged in blister packs. Blister packs as packaging for swallowable compositions are well known to those of ordinary skill in the art. Blister packs may be made of a transparent plastic sheet which has been formed to carry a matrix of depression or blisters. One or more formulated compositions are received in each depression or blister. A foil or plastic backing is then adhered across the plane of the sheet sealing the formulated compositions in their respective blisters. Examples of materials used for the blister packs include, but are not limited to, aluminum, paper, polyester, PVC, and polypropylene. Alternative materials are known to those of ordinary skill in the art. To remove a formulated composition, the depression material is pressed in and the composition is pushed through the backing material. Multiple blister packs may be placed in an outer package, often a box or carton for sale and distribution.

In another embodiment, the formulated composition of the present invention is packaged in a bottle. The bottle may be glass or plastic in form with a pop or screw top cap. Bottle packaging for formulated compositions are well known to those of ordinary skill in the art. Additionally, the unit dose forms may be individually wrapped, packaged as multiple units on paper strips or in vials of any size, without limitation. The formulated compositions of the invention may be packaged in unit dose, rolls, bulk bottles, blister packs, and combinations thereof, without limitation.

As used herein, “formulated as a food additive” means formulated into a solid form (e.g., powder, tablet, pellet, etc.) or a liquid form (e.g., suspension, emulsion, mixture, etc.) to facilitate adding the composition to food as a food additive. For example, it may be desirable to add the composition to food or liquid during manufacturing or it may be desirable for a consumer to add the composition at the time of preparing and/or consuming a snack or meal. The particular manner of formulation will, therefore, depend on the food the composition will be added to and the point at which it will be added.

In one embodiment, the composition of the present invention formulated as a food additive is added to food. For example, and without limitation, the composition may be added to sauce, tea, candy, cereals, breads, fruit mixes, fruit salads, salads, snack bars, fruit leather, health bars, granola, smoothies, soups, juices, cakes, pies, shakes, ice cream, and health drinks. The composition formulated as a food additive may have any of the additives described supra for the oral dosage formulations.

Typically, the compositions of the present invention will contain from about 0.01% to about 99%, about 1% to about 99%, about 5% to about 95%, or about 10% to about 90% defatted microalgae.

In one embodiment, the compositions of the present invention further include phytase. The phytase may be included in the compositions in an amount (e.g., on a weight/weight basis) of less than, equal to, or more than the amount of microalgae in the compositions. For example, and without limitation, the compositions may include phytase at an amount that is about 99%, 98%, 97%, 96%, 95%, 90%, 80%, 70%, 60%, 50%, 40%, 30%, 20%, 10%, 5%, 4%, 3%, 2%, or 1% less than or more than the amount of microalgae in the compositions.

Phytases are a specific group of monoester phosphatases required to initiate the release of phosphate from phytate (myo-inositol hexophosphate), the major storage form of phosphate in cereal foods or feeds (Reddy, et al., “Phytates in Legumes and Cereals,” Advances in Food Research 28:1 (1982), which is hereby incorporated by reference in its entirety). Like swine and poultry, humans are simple-stomached animals that have little phytase activity in their gastrointestinal tracts. Nearly all of the ingested phytate phosphate is indigestible. This results in the need for supplementation of inorganic phosphate, an expensive and non-renewable nutrient, in diets. In agriculture, the unutilized phytate-phosphate excreted through manure becomes environmental phosphate pollution (Cromwell, et al., “P—A Key Essential Nutrient, Yet a Possible Major Pollutant—Its Central Role in Animal Nutrition,” Biotechnology In the Feed Industry; Proceedings Alltech 7th Annual Symposium, p. 133 (1991), which is hereby incorporated by reference in its entirety). Furthermore, phytate chelates with essential trace elements like zinc produces nutrient deficiencies such as growth and mental retardation in children ingesting mainly plant origin foods without removal of phytate.

PhyA and phyB, from Aspergillus niger NRRL3135 have been cloned and sequenced (Ehrlich, et al., “Identification and Cloning of a Second Phytase Gene (phys) from Aspergillus niger (ficuum),” Biochem. Biophys. Res. Commun. 195:53-57 (1993); Piddington, et al., “The Cloning and Sequencing of the Genes Encoding Phytase (phy) and pH 2.5-optimum Acid Phosphatase (aph) from Aspergillus niger var. awamori,” Gene 133:56-62 (1993), which are hereby incorporated by reference in their entirety). Other phytase genes have been isolated from Aspergillus terreus and Myceliophthora thermophila (Mitchell et al., “The Phytase Subfamily of Histidine Acid Phosphatases: Isolation of Genes for Two Novel Phytases From the Fungi Aspergillus terreus and Myceliophthora thermophila,” Microbiology 143:245-252, (1997), which is hereby incorporated by reference in its entirety), Aspergillus fumigatus (Pasamontes et al., “Gene Cloning, Purification, and Characterization of a Heat-Stable Phytase from the Fungus Aspergillus fumigatus,” Appl. Environ. Microbiol. 63:1696-1700 (1997), which is hereby incorporated by reference in its entirety), Emericella nidulans and Talaromyces thermophilus (Pasamontes et al., “Cloning of the Phytase from Emericella nidulans and the Thermophilic Fungus Talaromyces thermophilus,” Biochim. Biophys. Acta. 1353:217-223 (1997), which is hereby incorporated by reference in its entirety), and maize (Maugenest et al., “Cloning and Characterization of a cDNA Encoding a Maize Seedling Phytase,” Biochem. J. 322:511-517 (1997), which is hereby incorporated by reference in its entirety).

Various types of phytase enzymes have been isolated and/or purified from Enterobacter sp. 4 (Yoon et al., “Isolation and Identification of Phytase-Producing Bacterium, Enterobacter sp. 4, and Enzymatic Properties of Phytase Enzyme,” Enzyme and Microbial Technology 18:449-454 (1996), which is hereby incorporated by reference in its entirety), Klebsiella terrigena (Greiner et al., “Purification and Characterization of a Phytase from Klebsiella terrigena,” Arch. Biochem. Biophys. 341:201-206 (1997), which is hereby incorporated by reference in its entirety), and Bacillus sp. DS11 (Kim et al., “Purification and Properties of a Thermostable Phytase from Bacillus sp. DS11,” Enzyme and Microbial Technology 22:2-7 (1998), which is hereby incorporated by reference in its entirety). Properties of these enzymes have been studied. In addition, the crystal structure of phy A from Aspergillus ficuum has been reported (Kostrewa et al., “Crystal Structure of Phytase from Aspergillus ficuum at 2.5 A Resolution,” Nature Structure Biology 4:185-190 (1997), which is hereby incorporated by reference in its entirety).

Hartingsveldt et al. “Cloning, Characterization and Overexpression of the Phytase-Encoding Gene (phyA) of Aspergillus Niger,” Gene 127:87-94 (1993), which is hereby incorporated by reference in its entirety, introduced phyA gene into A. niger and obtained a ten-fold increase of phytase activity compared to the wild type. Supplemental microbial phytase of this source in the diets for pigs and poultry has been shown to be effective in improving utilization of phytate-phosphate and zinc (Simons et al., “Improvement of Phosphorus Availability By Microbial Phytase in Broilers and Pigs,” Br. J. Nutr. 64:525 (1990); Lei et al., “Supplementing Corn-Soybean Meal Diets With Microbial Phytase Linearly Improves Phytate P Utilization by Weaning Pigs,” J. Anim. Sci. 71:3359 (1993); Lei et al., “Supplementing Corn-Soybean Meal Diets With Microbial Phytase Maximizes Phytate P Utilization by Weaning Pigs,” J. Anim. Sci. 71:3368 (1993); Cromwell et al., “P—A Key Essential Nutrient, Yet a Possible Major Pollutant—Its Central Role in Animal Nutrition,” Biotechnology In the Feed Industry; Proceedings Alltech 7th Annual Symposium, p. 133 (1991), which are hereby incorporated by reference in their entirety).

Yeast can be used to produce enzymes effectively while grown on simple and inexpensive media. With a proper signal sequence, the enzyme can be secreted into the media for convenient collection. Some yeast expression systems have the added advantage of being well accepted in the food industry and are safe and effective producers of food products. Pichia pastoris is a methylotrophic yeast, capable of metabolizing methanol as its sole carbon source. This system is well-known for its ability to express high levels of heterologous proteins. Because it is a eukaryote, Pichia has many of the advantages of higher eukaryotic expression systems such as protein processing, folding, and post-transcriptional modification.

A method of producing phytase in yeast by introducing a heterologous gene which encodes a protein or polypeptide with phytase/acid phosphatase activity into a yeast strain and expressing that gene is disclosed in U.S. Pat. No. 8,993,300 to Lei, which is hereby incorporated by reference in its entirety. In particular, a protein or polypeptide having phytase activity with optimum activity in a temperature range of 57° C.-65° C. at a pH of 2.5 to 3.5 or of 5.5, which an optimal pH at 2.5 to 3.5, is taught to be particularly important for phytase, because that is the stomach pH of animals. A yeast cell carrying a heterologous gene which encodes a protein or polypeptide with phytase activity and which is functionally linked to a promoter capable of expressing phytase in yeast is also disclosed. In addition, a vector having a gene from a non-yeast organism which encodes a protein or polypeptide with phytase activity, a promoter which is capable of initiating transcription in yeast functionally linked to the gene encoding a peptide with phytase activity, and with an origin of replication capable of maintaining the vector in yeast or being capable of integrating into the host genome is also taught. Thus, methods for producing a protein or polypeptide having phytase activity are known, including an isolated appA gene, which encodes a protein or polypeptide with phytase activity, can be expressed in a host cell. Also known are methods of converting phytate to inositol and inorganic phosphate. The appA gene expresses a protein of polypeptide with phytase activity in a host cell. The protein or polypeptide is then contacted with phytate to catalyze the conversion of phytate to inositol and inorganic phosphate.

Commercial phytases are commercially available as animal feed supplements, and include, without limitation, RONOZYME® HiPhos from DSM N.V. (Heerlen, NL), FINASE EC from AB Vista (Marlborough, UK), and PHYZYME® XP ENZYME from Verenium (San Diego, Calif.).

A further aspect of the present invention relates to a method of treating iron deficiency in an iron deficient animal. This method involves identifying an iron deficient animal and administering to the iron deficient animal a composition comprising microalgae in a solid, powder, or liquid form formulated for oral administration under conditions effective to treat the iron deficient animal.

Another aspect of the present invention relates to a method of treating iron deficiency in an iron deficient animal. This method involves identifying an iron deficient animal and administering to the iron deficient animal a composition comprising microalgae formulated as a food additive under conditions effective to treat the iron deficient animal.

Diagnostic tests for determining iron deficiency in an animal (e.g., a human) are known and include, for example and without limitation, tests to look for red blood cell size and color, hematocrit, hemoglobin, and ferritin. With iron deficiency anemia, red blood cells are smaller and paler in color than normal. Hematocrit is the percentage of blood volume made up by red blood cells. Normal levels in human are generally between 34.9 and 44.5 percent for adult women and 38.8 to 50 percent for adult men. These values may change depending on age. Lower than normal hemoglobin levels also indicate anemia. The normal hemoglobin range is generally defined as 13.5 to 17.5 grams (g) of hemoglobin per deciliter (dL) of blood for men and 12.0 to 15.5 g/dL for women. The normal ranges for children vary depending on the child's age and sex. Ferritin protein helps store iron in the body, and a low level of ferritin usually indicates a low level of stored iron.

Additional diagnostic tests for determining iron deficiency include endoscopy, colonoscopy, and ultrasound. With endoscopy, doctors can check for bleeding from hiatal hernia, an ulcer, or the stomach with the aid of endoscopy. In this procedure, a thin, lighted tube equipped with a video camera is passed down the throat to the stomach. This allows the doctor to view the esophagus and stomach to look for sources of bleeding. Lower intestinal sources of bleeding may be detected with a colonoscopy. By this procedure, a thin, flexible tube equipped with a video camera is inserted into the rectum and guided to the colon. Women may have a pelvic ultrasound to look for the cause of excess menstrual bleeding, such as uterine fibroids.

In these and the other methods of the present invention, the animal is, according to one embodiment, a human. Other animals may also benefit from the methods of the present invention. These animals include, without limitation, ruminants, poultry, swine, aquaculture, pets, dogs, cats, horses, zoo animals, mice, rats, rabbits, guinea pigs, and hamsters.

In one embodiment of these and the other methods of the present invention, the microalgae in the composition comprises defatted microalgae, as described supra, although full-fatted microalgae or a combination of defatted and full-fatted microalgae may also be used in the compositions suitable for the treatment methods of the present invention. Regardless of whether the microalgae is defatted or full-fat, in one embodiment, the microalgae possesses the characteristics of the microalgae in the compositions of the present invention described supra, except that full-fatted algae will have a higher oil content than the defatted microalgae.

In carrying out these and the other methods of the present invention, administering a microalgae containing composition is carried out orally, for example, by administering a tablet, capsule, or liquid, or by feeding the animal food containing the composition formulated as a food additive. In this and the other methods of the present invention, administering a microalgae containing composition formulated for oral administration or formulated as a food additive may be carried out once or multiple times a day or a week according to need, including the level of iron deficiency anemia in the animal, the type of animal, the age, sex, height, and weight of the animal, and other relevant considerations, including diet, other medical conditions (e.g., pregnancy), etc. Administration may need to occur for several days or up to several weeks or months, according to dietary consumption of iron and or general health, and may be monitored by a doctor. Several months of treatment (i.e., administering of microalgae containing compositions) may be necessary to improve the iron deficiency condition of the animal. During administration, iron deficiency status of the animal may be monitored by doing a complete blood count to look at the shape, color, number, and size of blood cells. Iron tests, which measure the amount of iron in the blood may also be performed. A reticulocyte count, to see how well treatment is working may also be performed. Reticulocytes are immature red blood cells produced by the bone marrow and released into the bloodstream. When reticulocyte counts increase, it usually means that iron replacement treatment is effective. A ferritin level test, which reflects how much iron may be stored in the body may also be performed.

Pregnant women and young children are often at greatest risk of iron deficiency anemia. In carrying out this and other methods of the present invention, pregnant women may be administered about 60 mg iron (via the microalgae containing compositions of the present invention) daily for about 6 months in pregnancy. For children ages 6-24 months, about 12.5 mg iron (via the microalgae containing compositions of the present invention) may be administered. For children ages 2-5, about 20-30 mg iron (via the microalgae containing compositions of the present invention) may be administered. For children 6-11 years of age, about 30-60 mg iron (via the microalgae containing compositions of the present invention) may be administered. For adolescents and adults, about 60 mg of iron (via the microalgae containing compositions of the present invention) may be administered. These are general guidelines, and more or less iron may be administered (via the microalgae containing compositions of the present invention) as necessary to treat the animal.

Yet another aspect of the present invention relates to a method of preventing iron deficiency in an animal. This method involves administering to an animal a composition comprising microalgae in a solid, powder, or liquid form formulated for oral administration under conditions effective to prevent iron deficiency in the animal.

Yet a further aspect of the present invention relates to a method of preventing iron deficiency in an animal. This method involves administering to an animal a composition comprising microalgae formulated as a food additive under conditions effective to prevent iron deficiency in the animal.

Still another aspect of the present invention relates to a method of hemoglobin repletion in a hemoglobin deficient animal. This method involves identifying a hemoglobin deficient animal and administering to the hemoglobin deficient animal a composition comprising microalgae in a solid, powder, or liquid form formulated for oral administration under conditions effective to replete hemoglobin in the animal.

Still a further aspect of the present invention relates to a method of hemoglobin repletion in a hemoglobin deficient animal. This method involves identifying a hemoglobin deficient animal and administering to the hemoglobin deficient animal a composition comprising microalgae formulated as a food additive under conditions effective to replete hemoglobin in the animal.

In one embodiment, one or more of the methods of the present invention is carried out to treat iron deficiency anemia in the animal. The iron deficiency anemia may be caused by poor bioavailability of iron to the animal. In another embodiment, the iron deficient animal suffers from low iron intake.

### EXAMPLES

The following examples are provided to illustrate embodiments of the present invention but are by no means intended to limit its scope.

### Example 1—Defatted Microalgae and Phytase for Improving Iron Nutrition and Preventing Anemia

Materials and Methods

Animal Husbandry

Protocols were approved by the Institutional Animal Care and Use Committee of Cornell University (Ithaca, N.Y.). All pigs were crossbred (Hampshire×Yorkshire×Landrace) gilts or barrows from the Cornell University Swine Farm (Ithaca, N.Y.). Pigs were given 50 mg of iron at birth and were weaned at 4 weeks of age. The creep feed was an iron deficient diet (negative control diet). Diet formulations were based on corn and soybean meal and algae was added at the respective amounts for each experiment in partial substitution for corn and soybean meal. Crystalline amino acids, minerals, and vitamins were added to satisfy nutrient requirements (as recommended by NRC, 1998). All diets were designed to be isocaloric and isonitrogenous. Proximate and mineral analyses were completed by Dairy One, Inc. (Ithaca, N.Y.). Diet compositions are shown in Tables 1 and 2. All pigs were penned (1×2.5 m) individually in an environmentally controlled barn with a temperature range of 21° C. to 26° C., a light cycle of 12 hr light to 12 hr dark, and were provided feed and water ad libitum. Feed intake of individual pigs was recorded daily. Pigs were weighed and blood was drawn from the anterior vena cava using 5 mL heparin-containing tubes (Vacutainer BD Biosciences, Bedford, Mass.) after an 8 hr fast.

TABLE 1
Composition of the Experiment 1 and 2 Diets (%)

| | Experiment #1 | | Experiment #2 | |
|---|---|---|---|---|
| | Fe- | 15% | Fe- | 7.5% |
| Diet | Adequate | Algae | Deficient | Algae |
| Corn, grain | 66.80 | 62.20 | 66.90 | 65.00 |
| Soybean meal 48% CP | 25.85 | 15.55 | 25.85 | 20.25 |
| Spray-dried plasma protein | 1.50 | 1.50 | 1.50 | 1.50 |
| Corn Oil | 2.00 | 2.00 | 2.00 | 2.00 |
| Calcium Carbonate | 1.30 | 1.30 | 1.30 | 1.30 |
| Sodium Phosphate | 1.11 | 1.11 | 1.11 | 1.11 |
| Lys-HCl | 0.25 | 0.25 | 0.25 | 0.25 |
| Threonine | 0.05 | 0.05 | 0.05 | 0.05 |
| Vit/Min Premix + | 0.25 | 0.25 | 0.25 | 0.25 |
| Cornmeal¹ | | | | |
| FeSO4 + corn meal² | 0.10 | 0.00 | 0.00 | 0.00 |
| Tylan 10 | 0.50 | 0.50 | 0.50 | 0.50 |
| MgO4 | 0.04 | 0.04 | 0.04 | 0.04 |
| NaCl | 0.25 | 0.25 | 0.25 | 0.25 |
| Algae | — | 15.00 | — | 7.50 |
| Calculated values | | | | |
| ME, kcal/kg | 3326 | 3151 | 3302 | 3275 |
| Crude Protein, % | 18.9 | 19.3 | 18.9 | 19.0 |
| Lysine, % | 1.33 | 1.34 | 1.33 | 1.33 |
| Methionine, % | 0.33 | 0.34 | 0.33 | 0.34 |
| Threonine, % | 0.86 | 0.88 | 0.86 | 0.87 |
| Ca, % | 0.67 | 0.67 | 0.67 | 0.67 |
| P, % | 0.59 | 0.61 | 0.59 | 0.60 |
| Fe, mg/kg | 104 | 429 | 65 | 247 |

¹Provided per kilogram of diet: Zn, 138 mg as ZnO; Cu, 24 mg as CuSO₄; Mn, 14 mg as MnSO₄; I, 0.2 mg as KI; Se, 0.7 mg as Na₂SeO₃; Mg, 2 mg as MgSO₄; Vitamin A, 2200 IU; Vitamin D, 220 IU; Vitamin E, 16 IU, Vitamin K, 0.63 mg; biotin 1.25 mg; choline, 0.83 g; Folacin, 0.38 mg; Niacin, 15 mg; panthothnate, 10 mg; rivoglavin, 4 mg; thiamin, 1 mg; Vitamin B6, 2 mg, Vitamin B12, 2 mg
²Provided per kilogram of diet: Fe, 38 mg as FeSO₄

TABLE 2
Diet Composition for Experiment 3¹

| | Diet 1 | Diet 2 | Diet 3 | Diet 4 | Diet 5 | |
|---|---|---|---|---|---|---|
| Iron | − | + | − | − | − | |
| Algae | − | − | + | − | + | |
| Phytase | − | − | − | + | + | DFA² |
| Proximate | | | | | | |
| composition, % | | | | | | |
| Moisture | 11.1 | 10.2 | 9.3 | 8.2 | 9 | 4.0 |
| Crude fat | 4.7 | 4.3 | 4.8 | 4.6 | 4.7 | 5.2 |
| CP | 19.8 | 19.6 | 19.9 | 19.4 | 19.9 | 43.9 |
| Ash | 5.4 | 5.2 | 5.2 | 5.2 | 5.3 | 20.6 |
| ADF | 3.5 | 2.6 | 3.0 | 3.3 | 3.6 | 3.1 |
| NDF | 7.2 | 7.9 | 7.5 | 7.7 | 6.9 | 19.1 |
| Mineral | | | | | | |
| Ca, % | 0.72 | 0.67 | 0.64 | 0.66 | 0.76 | 0.56 |
| P, % | 0.54 | 0.53 | 0.57 | 0.53 | 0.56 | 0.74 |
| Mg, % | 0.15 | 0.15 | 0.16 | 0.14 | 0.15 | 0.66 |
| K, % | 0.82 | 0.80 | 0.83 | 0.78 | 0.81 | 1.66 |
| Na, % | 0.36 | 0.36 | 0.40 | 0.39 | 0.40 | 3.87 |
| Fe, ppm | 64 | 70.0 | 72.0 | 69.0 | 76.0 | 2620 |
| Zn, ppm | 122 | 109 | 122 | 117 | 119 | 45 |
| Cu, ppm | 18 | 11 | 9 | 7 | 9 | 11 |
| Mn, ppm | 18 | 18 | 18 | 17 | 19 | 216 |
| Mo, ppm | 1.1 | 1.2 | 1.2 | 1.0 | 1.1 | 2.2 |
| Amino acids³, % | | | | | | |
| Arg | 1.3 | 1.3 | 1.3 | 1.3 | 1.3 | 1.3 |
| Cys | 0.4 | 0.4 | 0.4 | 0.4 | 0.4 | 0.4 |
| His | 0.5 | 0.5 | 0.5 | 0.5 | 0.5 | 0.5 |
| Ile | 0.8 | 0.8 | 0.8 | 0.8 | 0.8 | 0.8 |
| Leu | 1.8 | 1.8 | 1.8 | 1.8 | 1.8 | 1.8 |
| Lys | 1.3 | 1.3 | 1.3 | 1.3 | 1.3 | 1.3 |
| Met | 0.3 | 0.3 | 0.3 | 0.3 | 0.3 | 0.3 |
| Phe | 1.0 | 1.0 | 1.0 | 1.0 | 1.0 | 1.0 |
| Thr | 0.8 | 0.8 | 0.8 | 0.8 | 0.8 | 0.8 |
| Trp | 0.2 | 0.2 | 0.2 | 0.2 | 0.2 | 0.2 |
| Tyr | 0.7 | 0.7 | 0.7 | 0.7 | 0.7 | 0.7 |
| Val | 1.0 | 1.0 | 1.0 | 1.0 | 1.0 | 1.0 |

¹Proximate and mineral analyses were carried out by Dairy One Coop Inc. (Ithaca, NY).
²DFA = Defatted Microalgae, Nannochloropsis oceanica, Cellana, Kailua-Kona, HI.
³Calculate Values.

Experimental Design

Experiment 1: At 6 weeks of age, pigs (n=20) were determined non-anemic by hemoglobin and hematocrit measurements; 12.1±1.8 g/dL Hb and 34.8±4.7% PCV, respectively. Pigs were then fed 1 of 2 dietary treatments: 1) adequate iron diet or 2) 15% algae diet for 5 weeks (10 pigs/treatment). Digestibility was determined by supplementing the diet with 0.2% Cr₂O₃ during week 3. Feces were collected for 3 days by grab-sampling after 2 days of feeding Cr₂O₃ supplemented diets.

Experiment 2: At 6 weeks of age, pigs (n=10) were determined anemic by hemoglobin and hematocrit measurements; 8.2±1.0 g/dL Hb and 27.5±3.0% PCV, respectively. Pigs were then fed 1 of 2 dietary treatments: 1) iron-deficient diet or 2) 7.5% algae diet for 5 weeks (5 pigs/treatment). Digestibility was determined by supplementing the diet with 0.2% Cr₂O₃ during week 3. Feces were collected for 3 days by grab-sampling after 2 days of feeding Cr₂O₃ supplemented diets.

Experiment 3: At 6 weeks of age, pigs (n=30) were allotted to one of 5 dietary treatment groups (6 pigs/group): 1) Negative Control (low iron), 2) Positive Control (adequate iron), 3) Algae (low iron+algae), 4) Phytase (low iron+phytase), 5) Algae+Phytase (low iron+algae+phytase). Defatted green microalgae, Nannochloropsis oceanica (Cellana, Kailua-Kona, Hi.), was added to the respective diets at 0.5% in partial substitution for soybean meal and ground corn. This level was selected because it supplied enough iron to meet NRC requirements for swine. Phytase (OptiPhos 900K Instantized, Huvepharma, Peachtree City, Ga.) was added at 500 IU of phytase/kg of diet. Pigs were weighed and blood was drawn at 0, 2, 4, and 6 weeks of the experiment after an 8 hr fast.

Plasma Analyses

Blood hemoglobin were measured by the colorimetric cyanomethemogloblin method (Drabkin's reagent, Sigma-Aldrich Co., St. Louis, Mo.). Packed cell volume was determined using heparinized microcapillay tubes (Fisher Scientific). Total hemoglobin iron was estimated using the following formula: Hb Fe, mg=[body weight (g)×0.067 mL blood/g BW]×hemoglobin (g/mL)×3.35 mg Fe/g Hb.

Blood was held on ice during collection, centrifuged at 2,000 g for 20 minutes at 4° C., and stored at −80° C. until analyses. Plasma urea nitrogen was measured using Urea Nitrogen Reagent Set from Pointe Scientific, Inc (Canton, Mich.). Plasma glucose levels were determined spectrophotometrically with glucose assay kit GAG020 (Sigma-Aldrich, Sigma Chemical Co., St. Louis, Mo.). Plasma non-esterified fatty acids (NEFA), triglyceride (TAG), and total cholesterol (CHOL) were analyzed using commercial enzymatic kits following the manufacturer's protocols (Wako Pure Chemical Industries, Ltd., Richmond, Va.).

Digestibility Determination

Collected feces were pooled and dried for 5 days at 95° C. Cr₂O₃ concentration was measured in dried feed and feces according to Bolin et al., “A Simplified Method for Determination of Chromic Oxide (Cr₂)₃ When Used as an Inert Substance,” Science 116:634-635 (1952), which is hereby incorporated by reference in its entirety. Briefly, 100 mg of dried feeds or feces were digested with 5 mL of oxidizing reagent (10 g sodium molybdate in 150 ml distilled water+150 mL concentrated sulfuric acid+200 mL of 70% perchloric acid) at 200° C. for 4 hours. After cool down, digested samples were transferred into 50 mL volumetric flasks and the flask was filled with water. Optical density was read at 400 nm with known amount of chromic oxide standard.

Amino Acid Analysis

Approximately 50 mg of dried feed and feces were acid hydrolyzed, with n-valine as an internal standard, according to AOAC 994.12. Quantitative analysis was done on a high performance liquid chromatography system (Shimadzu Co., Japan) equipped with a pump (LC-10 Ai), florescent detector (RF-10AXL), and controller (SCL-10A). Reverse phase C-18 column (Zorbax Eclipse Plus C18, 250×2.6 mm, 5 μm, Agilent) was used. Mobile phase A included 10 mM Na₂HPO₄ and 10 mM Na₂B₄O₇.10H₂O, adjusted to pH 8.4 with concentrated HCL. Mobile phase B was acetonitrile-methanol-water mixture (45:45:10). The hydrolyzed samples were automatically derivatized with OPA by programming the autosampler (SIL-10Ai, Shimadzu Co., Japan). Samples were injected into the HPLC column at 40° C. with detection excitation at 350 nm and emission at 450 nm. Separation was performed at a flow rate of 1.2 mL per minute employing a solvent gradient (vol. %). Mobile phase B concentration was 0 min, 2%; 2 min, 2%; 45 min 57%; 45.1 min, 100%; 51 min, 100%; 51.1 min, 2%. Amino acid concentration was standardized with n-valine.

Statistical Analysis

All data were analyzed using analysis of variance (ANOVA) to test for main effects of diet and sex with or without time-repeated measurements using PC-SAS (Version 9.1, SAS Institute, Inc., Cary, N.C.) general linear models procedure. However, there were no main effects of sex; therefore, sex was removed from the model statements. Significance levels for differences were P<0.05. Individually penned pigs were considered the experimental unit. The Bonferroni/Dunn t-test was used to compare treatment means for Experiments 1 and 2.

Results

Experiment 1

There was no effect of diet on whole body weight (“WBW”), average daily gain (“ADG”), average daily feed intake (“ADFI”), or feed efficiency. There was also no difference in hematocrit, hemoglobin, or hemoglobin iron after 5 weeks of dietary treatments (Table 3). Dry matter digestibility was greater in the 15% algae diet. The 15% algae diet also had greater amino acid digestibility for all amino acids except GLN and THR. However, there was no difference in plasma urea nitrogen contents between the adequate diet and the 15% algae diet (Table 4).

TABLE 3
Effects of Algae on Growth Performance of Weanling Pigs
for Experiments 1 and 2^{1,2}

| | Experiment 1 | | Experiment 2 | |
|---|---|---|---|---|
| | Fe Adequate | 15% Algae | Fe Deficiency | 7.5% Algae |
| Diet | (n = 10) | (n = 10) | (n = 5) | (n = 6) |

Body weight, kg

| | | | | |
|---|---|---|---|---|
| Initial | 13.1 ± 2.9 | 12.7 ± 2.7 | 11.5 ± 1.6 | 11.1 ± 2.2 |
| Final | 33.8 ± 6.6 | 34.5 ± 5.4 | 31.8 ± 7.0 | 33.5 ± 5.0 |

Average daily gain, g/day

| | | | | |
|---|---|---|---|---|
| Initial | 415 ± 170 | 475 ± 158 | 376 ± 121 | 445 ± 154 |
| Final | 751 ± 174 | 803 ± 174 | 742 ± 163 | 852 ± 96 |
| Overall | 590 ± 120 | 622 ± 105 | 566 ± 161 | 640 ± 94 |

Average daily feed intake, g/day

| | | | | |
|---|---|---|---|---|
| Initial | 963 ± 108 | 959 ± 164 | 737 ± 135 | 879 ± 182 |
| Final | 1853 ± 95 | 2037 ± 159 | 1678 ± 379 | 1935 ± 159 |
| Overall | 1343 ± 77 | 1458 ± 144 | 1169 ± 282 | 1381 ± 146 |

Feed efficiency

| | | | | |
|---|---|---|---|---|
| Initial | 0.42 ± 0.17 | 0.50 ± 0.17 | 0.49 ± 0.18 | 0.46 ± 0.09 |
| Final | 0.40 ± 0.09 | 0.39 ± 0.09 | 0.41 ± 0.11 | 0.42 ± 0.03 |
| Overall | 0.44 ± 0.08 | 0.43 ± 0.09 | 0.45 ± 0.17 | 0.45 ± 0.03 |

Packed cell volume, %

| | | | | |
|---|---|---|---|---|
| Initial | 34.5 ± 4.3 | 35.1 ± 5.3 | 26.0 ± 2.2 | 28.7 ± 3.5 |
| Final | 36.8 ± 4.5 | 37.5 ± 3.2 | 34.1 ± 4.1^{b} | 39.8 ± 2.4^{a} |

Hemoglobin, g/dL

| | | | | |
|---|---|---|---|---|
| Initial | 11.9 ± 1.5^{x} | 12.3 ± 2.0^{x} | 8.1 ± 1.2^{y} | 8.3 ± 0.9^{y} |
| Final | 12.4 ± 1.8 | 13.2 ± 1.5 | 11.0 ± 1.5 | 13.0 ± 1.4 |

Hemoglobin iron, mg

| | | | | |
|---|---|---|---|---|
| Initial | 357.4 ± | 352.6 ± | 211.5 ± 55.8^{y} | 222.4 ± |
| | 121.6^{x} | 101.8^{x} | | 24.6^{y} |
| Final | 963.5 ± 292.5 | 1024.3 ± | 802.1 ± 277.0 | 1049.8 ± |
| | | 205.6 | | 75.3 |

¹Data are reported as Mean ± S.D. Means that do not have similar superscripts are considered significantly different (P ≦ 0.05). ^{a,b}Statistical analysis was conducted within each experiment. ^{x,y}Statistical analysis was conducted within 4 dietary treatments.
²Initial data were recorded at day 0 of study and final data were recorded at week 5 of study.

TABLE 4
Effects of Algae on Dry Matter Digestibility, Amino Acid Digestibility,
and Plasma Urea Nitrogen of Weanling Pigs in Experiments 1 and 2¹

| | Experiment 1 | | Experiment 2 | |
|---|---|---|---|---|
| | Fe Adequate | 15% Algae | Fe Deficiency | 7.5% Algae |
| Diet | (n = 10) | (n = 10) | (n = 5) | (n = 6) |

Dry matter digestibility, %

| | | | |
|---|---|---|---|
| 72.9 ± 5.3^{y,b} | 84.5 ± 2.7^{w,a} | 76.2 ± 2.5^{xy,b} | 78.4 ± 1.6^{x,a} |

Amino acid digestibility, %

| | | | | |
|---|---|---|---|---|
| ASP | 78.6 ± 0.9^{x,b} | 91.8 ± 4.3^{w,a} | 77.8 ± 4.7^{x,b} | 87.3 ± 1.3^{w,b} |
| GLC | 83.1 ± 0.8^{w,b} | 93.3 ± 3.1^{w,a} | 84.1 ± 3.6^{x,b} | 89.1 ± 2.0^{w,b} |
| SER | 83.1 ± 0.7^{c,b} | 94.8 ± 2.6^{w,a} | 85.5 ± 1.8^{xy} | 89.4 ± 3.2^{x} |
| GLN | 90.9 ± 2.7 | 97.7 ± 3.9 | 96.9 ± 6.1 | 91.2 ± 6.9 |
| GLY | 68.9 ± 2.9^{y,b} | 92.6 ± 3.2^{w,a} | 70.0 ± 8.6^{xy} | 83.2 ± 9.3^{x} |
| THR | 81.2 ± 5.3^{wx} | 91.9 ± 7.5^{w} | 63.4 ± 12.4^{y} | 73.3 ± 15.1^{xy} |
| ARG | 89.0 ± 4.2^{y,b} | 95.5 ± 0.6^{w,a} | 91.1 ± 4.9^{wx} | 92.7 ± 4.5^{wx} |
| ALA | 64.2 ± 2.6^{y,b} | 88.1 ± 3.8^{w,x} | 69.1 ± 8.0^{y} | 77.3 ± 6.8^{wx} |
| TYR | 75.5 ± 2.9^{y,b} | 92.1 ± 2.8^{w,a} | 79.9 ± 5.5^{y,b} | 86.0 ± 3.8^{b,a} |
| VAL | 67.8 ± 1.3^{z,b} | 89.4 ± 4.4^{w,a} | 74.5 ± 4.1^{y} | 80.3 ± 3.4^{wx} |
| PHE | 81.7 ± 1.0^{x,b} | 92.9 ± 3.0^{w,a} | 82.9 ± 4.4^{x} | 87.5 ± 3.2^{wx} |
| ILE | 73.9 ± 1.5^{xy,b} | 90.3 ± 5.1^{w,a} | 68.5 ± 13.1^{z,b} | 79.2 ± 4.1^{b,a} |
| Leu | 78.7 ± 1.4^{y,b} | 91.7 ± 3.1^{w,a} | 83.23 ± 6.2^{xy} | 87.2 ± 6.0^{x} |
| Lys | 80.1 ± 1.7^{xy,b} | 94.6 ± 2.3^{w,a} | 85.6 ± 3.6^{x} | 86.15 ± 5.0^{x} |

Plasma urea nitrogen², mg/dL

| | | | | |
|---|---|---|---|---|
| Initial | 12.34 ± 6.63 | 10.13 ± 4.37 | 11.58 ± 4.82 | 13.20 ± 9.62 |
| Final | 9.84 ± 1.96^{wx} | 11.74 ± 3.23^{w} | 9.14 ± 2.89^{wx} | 7.96 ± 1.45^{x} |

¹Data are reported as Mean ± S.D. Means that do not have similar superscripts are considered significantly different (P ≦ 0.05). ^{a,b}Statistical analysis was conducted within each experiment. ^{w,x,y,z}Statistical analysis was conducted within 4 dietary treatments.
²Initial data were recorded at day 0 of study and final data were recorded at week 5 of study.

Experiment 2

There was no effect of diet on WBW, ADG, ADFI, or feed efficiency. Pigs fed 7.5% algae had higher hematocrit, hemoglobin, and hemoglobin iron by day 21 of the study (Table 3). The 7.5% algae diet has greater dry matter digestibility when compared to the iron deficient diet. The 7.5% algae diet also had greater amino acid digestibility for ASP, GLC, TYR, and ILE. However, there was no difference in plasma urea nitrogen contents between the adequate diet and the 15% algae diet (Table 4, supra).

Experiment 3

At the start of the study, there was no difference in WBW or ADFI. By week 6, pigs fed the Phytase and Phytase+Algae diets were larger than pigs from other dietary treatments (Table 5). All pigs were considered anemic with an average hematocrit of 27.5±1.7% and hemoglobin of 9.4±0.6 g/dL. By week 6, pigs fed phytase and algae+phytase diets had hematocrit and hemoglobin values similar to those observed in pigs fed the iron-adequate diet (10.2±0.6% and 13.5±1.3 g/dL, respectively; Table 6). However, there was no effect of diet on the plasma lipid profile or plasma glucose content (Table 6).

TABLE 5
Growth and Feed Intake of Anemic Weanling Pigs in Experiment 3^{1,2}

| | Diet 1 | Diet 2 | Diet 3 | Diet 4 | Diet 5 | | | | |
|---|---|---|---|---|---|---|---|---|---|
| Iron | − | + | − | − | − | | | | |
| Algae | − | − | + | − | + | | P-Values | | |
| Phytase | − | − | − | + | + | SEM | Diet | Time | D × T |
| Body weight, kg | | | | | | | | | |
| Initial | 7.25^{a} | 7.50^{a} | 7.71a | 7.63^{a} | 7.51^{a} | 0.35 | 0.4128 | <0.0001 | 0.0034 |
| Final | 21.27^{a} | 27.61^{ab} | 27.9^{ab} | 29.4^{b} | 30.63^{b} | 2.43 | | | |
| Average daily gain, kg | | | | | | | | | |
| Initial | 0.24 | 0.31 | 0.37 | 0.35 | 0.40 | 0.07 | 0.0568 | <0.0001 | 0.5981 |
| Final | 0.53 | 0.68 | 0.85 | 0.73 | 0.83 | 0.06 | | | |
| Average daily feed intake, g | | | | | | | | | |
| Initial | 473^{a} | 561^{a} | 527^{a} | 610^{a} | 660^{a} | 80 | 0.0669 | <0.0001 | 0.0010 |
| Final | 877^{a} | 1187^{ab} | 1418^{b} | 1423^{b} | 1449^{b} | 124 | | | |
| FCR (feed use efficiency) | | | | | | | | | |
| Initial | 0.43 | 0.48 | 0.41 | 0.51 | 0.54 | 0.30 | 0.4850 | 0.0140 | 0.7567 |
| Final | 0.54 | 0.57 | 0.59 | 0.51 | 0.53 | 0.13 | | | |

¹Data are reported as LSMeans (n = 6 pigs/diet). Means that do not have similar superscripts are
considered significantly different (P ≦ 0.05).
²Initial data were recorded at day 0 of study and final data were recorded at week 6 of study.

TABLE 6
Blood Parameters of Anemic Weanling Pigs in Experiment 3^{1,2}

| | Diet 1 | Diet 2 | Diet 3 | Diet 4 | Diet 5 | | | | |
|---|---|---|---|---|---|---|---|---|---|
| Iron | − | + | − | − | − | | | | |
| Algae | − | − | + | − | + | | P-Values | | |
| Phytase | − | − | − | + | + | SEM | Diet | Time | D × T |
| Hematocrit, % | | | | | | | | | |
| Initial | 27.0^{a} | 28.8^{a} | 26.2^{a} | 26.8^{a} | 28.5^{a} | 1.7 | 0.2312 | <0.0001 | 0.0451 |
| Final | 28.3^{a} | 37.2^{b} | 34.3^{ab} | 38.8^{b} | 40.3^{b} | 3.0 | | | |
| Hemoglobin, g/dL | | | | | | | | | |
| Initial | 9.4^{a} | 10.2^{a} | 9.7^{a} | 8.5^{a} | 9.5^{a} | 0.6 | 0.1481 | <0.0001 | 0.0220 |
| Final | 10.0^{a} | 13.5^{b} | 12.9^{ab} | 14.9^{b} | 16.1^{b} | 1.3 | | | |
| Glucose³, | | | | | | | | | |
| Initial | 94.6 | 102.6 | 104.9 | 96.9 | 105.5 | 4.3 | 0.5593 | <0.0001 | 0.0792 |
| Final | 102.9 | 107.4 | 119.0 | 108.3 | 110.9 | 3.6 | | | |
| Total Cholesterol⁴, | | | | | | | | | |
| Initial | 94.7 | 106.7 | 123.9 | 136.4 | 129.4 | 14.4 | 0.0573 | <0.001 | 0.2900 |
| Final | 98.2 | 78.5 | 104.7 | 104.5 | 97.6 | 16.3 | | | |
| NEFA⁴, | | | | | | | | | |
| Initial | 393.6 | 420.9 | 381.4 | 571.5 | 570.3 | 81.0 | 0.0689 | <0.0001 | 0.3631 |
| Final | 152.9 | 130.2 | 92.3 | 189.1 | 130.3 | 30.3 | | | |
| Triglyceride⁴, | | | | | | | | | |
| Initial | 35.8 | 41.2 | 48.1 | 41.4 | 46.9 | 7.0 | 0.3698 | <0.0001 | 0.2170 |
| Final | 53.5 | 44.1 | 39.6 | 44.8 | 48.7 | 5.2 | | | |

¹Data are reported as LSMeans (n = 6 pigs/diet). Means that do not have similar superscripts are considered significantly different (P ≦ 0.05).
²Initial data were recorded at day 0 of study and final data were recorded at week 6 of study.
³Plasma glucose levels were determined spectrophotometrically with glucose assay kit GAG020 (Sigma-Aldrich, Sigma Chemical Co., St. Louis, MO).
⁴Plasma non-esterified fatty acids (NEFA), triglyceride (TAG), and total cholesterol (CHOL) were analyzed using commercial enzymatic kits following manufacturer's protocols (Wako Pure Chemical Industries, Ltd., Richmond, VA).

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A composition comprising defatted microalgae (i) in a solid, powder, or liquid form formulated for oral administration or (ii) formulated as a food additive.

2. (canceled)

3. The composition of claim 1, wherein the defatted microalgae comprises green marine microalgae.

4. The composition of claim 3, wherein the defatted microalgae comprises Nannochloropsis oceanica.

5. The composition of claim 1, wherein the defatted microalgae comprises 0.1%-50% of oil content compared to non-defatted microalgae.

6. The composition of claim 1, wherein the defatted microalgae comprises iron at a concentration of at least about 100 ppm.

7. The composition of claim 6, wherein at least about 10% of the iron is high availability iron.

8. The composition of claim 1 further comprising:
phytase.

9. A method of treating iron deficiency in an iron deficient animal, said method comprising:
identifying an iron deficient animal and
administering to the iron deficient animal a composition comprising microalgae (i) in a solid, powder, or liquid form formulated for oral administration or (ii) formulated as a food additive under conditions effective to treat the iron deficient animal.

10. (canceled)

11. The method of claim 9, wherein the animal is a human.

12. The method of claim 9, wherein the animal is selected from the group consisting of a ruminant, poultry, swine aquaculture, pet, dog, cat, horse, zoo animal, mouse, rat, rabbit, guinea pig, and hamster.

13. The method of claim 9, wherein the microalgae comprises defatted microalgae.

14. The method of claim 13, wherein the defatted microalgae comprises 0.1%-50% of oil content compared to non-defatted microalgae.

15. The method of claim 13, wherein the defatted microalgae comprises iron at a concentration of at least about 100 ppm.

16. The method of claim 15, wherein at least about 10% of the iron is high availability iron.

17. The method of claim 9, wherein the microalgae comprises green marine microalgae.

18. The method of claim 17, wherein the microalgae comprises Nannochloropsis oceanica.

19. The method of claim 9, wherein said administering is carried out orally.

20. The method of claim 9, wherein the composition is formulated as a food additive and said administering is carried out by adding the composition to a meal or snack consumed by the iron deficient animal.

21. The method of claim 9, wherein the composition further comprises phytase.

22. The method of claim 9, wherein said method is carried out to treat iron deficiency anemia in the animal.

23. The method of claim 22, wherein said iron deficiency anemia is caused by a lack of bioavailable iron in the animal's diet.

24. The method of claim 9, wherein the iron deficient animal suffers from low iron intake.

25. (canceled)

26. (canceled)

27. A method of hemoglobin repletion in a hemoglobin deficient animal, said method comprising:
identifying a hemoglobin deficient animal and
administering to the hemoglobin deficient animal a composition comprising microalgae (i) in a solid, powder, or liquid form formulated for oral administration or (ii) formulated as a food additive under conditions effective to replete hemoglobin in the animal.

28. (canceled)
